(19) United States
(12) Patent Application Publication
(10) Pub. No.: US 2019/0225723 A1
(43) Pub. Date: Jul. 25, 2019

(54) BETA-NUCLEATED PROPYLENE TERPOLYMER COMPOSITION WITH GOOD TOUGHNESS

(71) Applicant: BOREALIS AG, Vienna (AT)

(72) Inventors: Markus Gahleitner, Neuhofen/Krems (AT); Jingbo Wang, Linz (AT); Carl-Gustaf Ek, Vastra Frolunda (SE); Klaus Bernreitner, Linz (AT)

(21) Appl. No.: 16/336,795

(22) PCT Filed: Oct. 10, 2017
(86) PCT No.: PCT/EP2017/075721

§ 371 Date: Mar. 26, 2019

(30) Foreign Application Priority Data
Oct. 12, 2016 (EP) 16193410.4

(51) Int. Cl. C08F 210/16

(52) U.S. Cl. CPC C08F 210/16; C08F 2800/20

(57) ABSTRACT

The invention is related to a polymer composition comprising a propylene/ethylene/C4 to C10 α-olefin (GO) terpolymer, which has improved toughness, as well as the article made thereof. The invention also directs to a method for the preparation of the terpolymer and the polymer composition comprising said terpolymer.

The present invention relates to a polymer composition comprising a propylene/ethylene/C4 to C10 α-olefin (αO) terpolymer, which has improved toughness, as well as the article made thereof. The invention also directs to a method for the preparation of the terpolymer and the polymer composition comprising said terpolymer.

Polypropylene-based polymers have many characteristics which make them suitable for many applications like cables, pipes, fittings, moulded articles, foams etc. Polypropylene as pipe material is mainly used in non-pressure applications, like for cable protection as well as for culverts (e.g. road and rail), fittings and profiles. Polypropylene is also used for pressure pipes, mainly for hot water and industrial pipes, i.e. for the transport of liquid, e.g. water, during which the fluid can be pressurized. Moreover, the transported fluid may have varying temperatures, usually within the temperature range of about 0 to about 70° C. The good properties at high temperature of polypropylene compared to other polyolefins are often utilized for pipe applications but also for cable applications. All three main types of propylene polymers, i.e. homopolymers, random copolymers and block copolymers (i.e. heterophasic copolymers) are used.

In general, polypropylene-based materials to be chosen for different applications should result in products of excellent impact performance while still maintaining good stiffness. However, these properties are interrelated to each other and very often behave in a conflicting manner, i.e. improving a specific property can only be accomplished at the expense of another property.

Stiffness can be improved by increasing the amount of crystallized polypropylene fraction within the composition. However, as the consequence of the most common α-type crystallization, the material becomes more brittle, thereby resulting in poor impact properties. Furthermore, high brittleness is usually accompanied by lower resistance to slow crack growth, thereby having a detrimental effect on durability.

Thus, many efforts have been undertaken to provide polypropylene materials with a combination of impact strength and stiffness. The β-form of crystallized PP is generally known to improve impact strength and, specifically, the resistance towards slow crack growth in pipes.

EP2279216 discloses a β-nucleated propylene/1-hexene copolymer with an optimized balance of stiffness and toughness.

EP2657285 discloses a non-nucleated moulded polypropylene produced in the present of metallocene catalyst, which shows high content of β-form crystallization.

EP2014715 also discloses a polypropylene composition of homopolymer and random copolymer, where the composition is β-nucleated. In Comparative Example 3 a propylene-ethylene-butene-terpolymer with an MFR₂ of 0.29 g/10 min is described.

EP1312623 describes a further propylene-ethylene-butene-terpolymer. The terpolymer has an MFR₂ of 0.32 g/10 min

However, the β-form of isotactic polypropylene is metastable and only generated at certain conditions, especially with slow cooling and in the presence of one or more specific beta nucleating agents. It is also known that defects on the chain also disturb the formation of the β-form. In case of PP homopolymers, both stereo- and regio-errors can disturb formation of the β-modification; while in case of propylene random copolymers, higher amount of isolated ethylene units can do the same. It is generally difficult to obtain random PP copolymer with high amount of β-modification.

The object of the present invention is to provide an alternative random copolymer of polypropylene with an easy formation of β-modification, which enables the material with high impact strength while keeping the stiffness on high levels. The finding of the present invention is to provide a polymer composition based on a β-nucleated propylene/ethylene/C4 to C10 α-olefin terpolymer which is featured by specific weight content of ethylene and a C4 to C10 α-olefin (αO) present within the terpolymer.

Thus in a first aspect the present invention is directed to a polymer composition comprising a terpolymer (A) of propylene, ethylene and one C4 to C10 α-olefin (αO), characterized in that

i) the ethylene content in said terpolymer (A) is in the range of 0.1 to 8.0 wt % based on the total weight of the terpolymer (A),
ii) the C4 to C10 α-olefin (αO) content in said terpolymer (A) is in the range of 0.1 to 16.0 wt % based on the total weight of the terpolymer (A), and
iii) the melt flow rate MFR₂ of the terpolymer (A) measured according to ISO 1133 (230° C., 2.16 kg load) is 0.5 to below 12.0 g/10 min,
iv) the terpolymer (A) comprises a β-nucleating agent.

Optionally, in a specific embodiment of the present invention, the said polymer composition further comprises an elastomeric modifier (B), wherein the amount of said elastomeric modifier based on the total weight of polymer composition is in the range of 0-25 wt %.

It has been found that the β-nucleated polymer composition described in the present invention shows surprisingly high content of β-modification, leading to an outstanding impact performance while keeping the stiffness of material on the high level.

In the following the present invention are defined in more detail.

### Terpolymer (A)

It is essential that according to the present invention, the polymer composition comprises a terpolymer of propylene (C3), ethylene (C2) and C4 to C10 α-olefin (αO). Preferably the polymer composition comprises at least 75.0 wt %, preferably at least 80.0 wt %, more preferable at least 85.0 wt % of the terpolymer of C3, C2 and C4.

The term “terpolymer” indicates that the polymer comprises units derived from propylene and from two α-olefins other than propylene. More precisely the terpolymer according to this invention comprises three different units derived from propylene, ethylene and one C4 to C10 α-olefin (αO). In other words the terpolymer of the present invention is a terpolymer of propylene, ethylene and one C4 to C10 α-olefin (αO). Accordingly it is preferred that propylene, ethylene and one C4 to C10 α-olefin are the only monomers of the terpolymer. The C4 to C10 α-olefin can be any α-olefin, i.e. branched or linear α-olefin, like 1-butene, 1-pentene, 4-methyl-1-pentene, 1-hexene, 1-heptene 1-octene, 1-nonene or 1-decene, however 1-butene or 1-hexene are preferred. In a specific embodiment the terpolymer is a terpolymer of propylene, ethylene and 1-butene only.

Preferably, said terpolymer has a rather high content of propylene (C3), i.e. at least 76.0 wt %, i.e. equal or more than 78.0 wt %, more preferably equal or more than 80.0 wt %, yet more preferably equal or more than 85.0 wt %, like equal or more than 88.5 wt %.

Another preferred requirement of the terpolymer is that the amount of ethylene (C2) within the terpolymer is lower than the amount of the C4 to C10 α-olefin (αO). Accordingly it is preferred that the ethylene (C2) content within the terpolymer is in the range of 0.1 to 8.0 wt %, more preferably in the range of 0.3 to 7.0, even more preferably in the range of 0.4 to 6.0, like in the range of 0.5 to 3.0 wt %.

Further it is preferred that the content of the C4 to C10 α-olefin (αO), like the content of 1-butene, within the terpolymer is in the range of 0.1 to 16.0 wt %, more preferably in the range of 0.3 to 14.0, like in the range of 0.5 to 12.0 wt %.

It is especially preferred that the terpolymer has a total comonomer content in the range of 1.5 to 24.0 wt %, preferably in the range of 2.0 to 20.0 wt.-%, more preferably in the range of 2.5 to 18.0 wt.-%, like in the range of 3.0 to 16.0 wt.-%.

Further it is appreciated that the xylene cold soluble content (XCS) measured according to ISO 16152 (25° C.) of the terpolymer is not more than 12.0 wt-%, more preferably of not more than 10.0 wt.-%, yet more preferably of not more than 9.5 wt.-%, like not more than 9.0 wt.-%. Thus a preferred range is 1.0 to 12.0 wt.-%, more preferred 2.0 to 10.0 wt.-%, still more preferred 2.5 to 9.0 wt.-%.

The melt flow rate MFR₂ of the terpolymer (A) measured according to ISO 1133 (230° C., 2.16 kg load) is 0.5 to below 12.0 g/10 min, preferably 1.0 to 11.0 g/10 min and more preferably 1.5 to 10.0 g/10 min.

A further characteristic of the terpolymer is that it is produced by a Ziegler-Natta catalyst. Polypropylenes produced by a Ziegler-Natta catalyst are inter alia featured by a rather low amount of missinsertions of propylene within the polymer chain. Accordingly the terpolymer is featured by low amount of <2,1> regiodefects, i.e. of equal or below 0.4 mol.-%, more preferably of equal or below than 0.2 mol.-%, like of equal or below 0.1 mol.-%, determined by 13C-NMR spectroscopy. In one specific embodiment no <2,1> regiodefects are detectable.

Additionally it is appreciated that the terpolymer has a polydispersity (Mw/Mn) as determined by size exclusion chromatography of more than 3.0, preferably in the range of 3.0 to 16.0, more preferably in the range of 3.5 to 12.0, even more preferably in the range of 4.0 to 9.0.

Further it is appreciated that the terpolymer according to this invention at least has a melting temperature (Tm) measured according to ISO 11357-3 of not higher than 145° C., preferably in the range of 115 to 144° C., more preferably in the range of 120 to 143° C., still more preferably in the range of 122-142° C., like in the range of 124 to 140° C.

A further preferred requirement of the terpolymer in the present invention is that the terpolymer has at least one glass transition temperature T_{g} (measured with DMTA according to ISO 6721-7) in the range of −12 to +5° C., preferably in the range of −10 to +4° C., more preferably in the range of −8 to +3.5° C.

In addition the terpolymer in the present invention does not show a glass transition temperature T_{g} (measured with DMTA according to ISO 6721-7) lower than −20° C.

Accordingly, it is further appreciated that the terpolymer in the present invention has a crystallization temperature Tc measured according to ISO 11357-3 of equal or higher than 90° C., preferably in the range of 92 to 105° C., still more preferably in the range of 94 to 103° C.

### β-Nucleating Agent

As further requirement of the present invention, it is essential that the terpolymer (A) of propylene (C3), ethylene (C2) and C4 to C10 α-olefin (αO) comprises a β-nucleating agent.

Preferably, the inventive terpolymer (A) of propylene (C3), ethylene (C2) and C4 to C10 α-olefin (αO) is β-nucleated, i.e. the terpolymer (A) is partially crystallized in the ß-modification. Thus it is preferred that the amount of β-modification of the terpolymer (A) is at least 60%, more preferably at least 70%, still more preferably at least 75%, yet more preferably at least 78%, (determined by DSC using the second heat as described in detail in the example section).

As β-nucleating agent any nucleating agent can be used which is suitable for inducing crystallization of the terpolymer (A) in the hexagonal or pseudo-hexagonal modification. Preferred β-nucleating agents are those listed below, which also includes their mixtures.

Suitable types of ß-nucleating agents are
dicarboxylic acid derivative type diamide compounds from C5 to C8-cycloalkyl monoamines or C6 to C12-aromatic monoamines and C5 to C8-aliphatic, C5 to C8-cycloaliphatic or C6 to C12-aromatic dicarboxylic acids, e.g.
N, N′-di-C5-C8-cycloalkyl-2, 6-naphthalene dicarboxamide compounds such as N, N′-dicyclohexyl-2, 6-naphthalene dicarboxamide and N, N′-dicyclooctyl-2, 6-naphthalene dicarboxamide,
N,N-di-C5-C8-cycloalkyl-4,4-biphenyldicarboxamide compounds such as N, N′-dicyclohexyl-4, 4-biphenyldicarboxamide and N, N′-25 dicyclopentyl-4, 4-biphenyldicarboxamide,
N, N′-di-C5-C8-cycloalkyl-terephthalamide compounds such as N, N′-dicyclohexylterephthalamide and N, N′-dicyclopentylterephthalamide,
N, N′-di-C5-C8-cycloalkyl-1, 4-cyclohexanedicarboxamide compounds such as N, N′-dicyclo-hexyl-1,4-cyclohexanedicarboxamide and N, N′-dicyclohexyl-1, 4-cyclopentanedicarboxamide,
diamine derivative type diamide compounds from C5-C8-cycloalkyl monocarboxylic acids or C6-C12-aromatic monocarboxylic acids and C5-C8-cycloaliphatic or C6-C12-aromatic diamines, e. g.
N,N-C6-C12-arylene-bis-benzamide compounds such as N,N′-pphenylene-bis-benzamide and N,N′-1,5-naphthalene-bis-benzamide,
N,N′-C5-C8-cycloalkyl-bis-benzamide compounds such as N,N′-1,4-cyclopentane-bis-benzamide and N,N′-1,4-cyclohexane-bisbenzamide,
N,N-p-C6-C12-arylene-bis-C5-C8-cycloalkylcarboxamide compounds such as N,N′-1,5-naphthalene-bis-cyclohexanecarboxamide and N,N′-15 1,4-phenylene-bis-cyclohexanecarboxamide, and
N,N′-C5-C8-cycloalkyl-bis-cyclohexanecarboxamide compounds such as N,N′-1,4-cyclopentane-bis-cyclohexanecarboxamide and N,N′-1,4-cyclohexane-bis-cyclohexanecarboxamide,
amino acid derivative type diamide compounds from amidation reaction of C5-C8-alkyl, C5-C8-cycloalkyl- or C6-C12-arylamino acids, C5-C8-alkyl-, C5-C8-cycloalkyl- or C6-C12-aromatic monocarboxylic acid chlorides and C5-C8-alkyl-, C5-C8-cycloalkyl- or C6-C12-aromatic mono-amines, e.g.
N-phenyl-5-(N-benzoylamino)pentaneamide and N-cyclohexyl-4-(Ncyclohexyl-carbonylamino)benzamide.

Further suitable of ß-nucleating agents are
quinacridone type compounds, e.g.
   quinacridone, dimethylquinacridone and dimethoxyquinacridone,
quinacridonequinone type compounds, e. g. quinacridonequinone, a mixed crystal of 5,12-dihydro(2,3b)acridine-7,14-dione with quino(2,3b)acridine-6,7,13,14-(5H, 12H)-tetrone and dimethoxyquinacridonequinone and
dihydroquinacridone type compounds, e. g. 5 dihydroquinacridone, dimethoxydihydroquinacridone and dibenzodihydroquinacridone.

Still further suitable ß-nucleating agents are
dicarboxylic acid salts of metals from group IIa of periodic system, e. g.
   pimelic acid calcium salt and suberic acid calcium salt; and
mixtures of dicarboxylic acids and salts of metals from group IIa of periodic system.

Still further suitable ß-nucleating agents are
salts of metals from group IIa of periodic system and imido acids of the formula

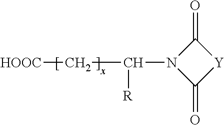

wherein x=1 to 4; R=H, —COOH, C1-C12-alkyl, C5-C8-cycloalkyl or C6-C12-aryl, and Y=C1-C12-alkyl, C5-C8-cycloalkyl or 06-C12-aryl-substituted bivalent C6-C12-aromatic residues, e. g. calcium salts of phthaloylglycine, hexahydrophthaloylglycine, Nphthaloylalanine and/or N-4-methylphthaloylglycine.

Preferred ß-nucleating agents are any one or mixtures of N, N′-dicyclohexyl-2, 6-naphthalene dicarboxamide, quinacridone type or pimelic acid calcium-salt (EP 0 682 066).

The amount of β-nucleating agents within the propylene copolymer is preferably up to 2.0 wt.-%, more preferably up to 1.5 wt.-%, like 1.0 wt.-%. Thus it is appreciated that the ß-nucleating agents are present within the terpolymer (A) from 0.0001 to 2.0000 wt.-%, more preferably from 0.0001 to 2.0000 wt.-%, yet more preferably from 0.005 to 0.5000 wt.-%.

### Elastomeric Modifiers (B)

As mentioned above, according to the present invention the polymer composition may optionally further comprise an elastomeric modifier (B).

In a preferred embodiment of the present invention, the polymer composition comprises up to 25 wt %, preferably up to 20 wt %, more preferably up to 15 wt % of elastomeric modifier (B), based on the total weight of polymer composition.

In an especially preferred embodiment of the present invention, the elastomeric modifier (B) can be a very low density ethylene copolymer; more preferably a very low density ethylene copolymer polymerized using single site, preferably metallocene catalyst. E.g. the elastomeric modifier (B) suitable for the current inventions can be a copolymer of ethylene and propylene or a C4-C10 alpha-olefin.

Suitable C4-C10 alpha-olefin include 1-butene, 1-hexene and 1-octene, preferably butene or octene and more preferably octene.

Preferably copolymers of ethylene and 1-octene are used.

Suitable elastomeric modifier (B) has a density in the range of 0.850-0.890 g/cm³, preferably in the range of 0.855 to 0.888 g/cm³, more preferably in the range of 0.860-0.886 g/cm³.

The ethylene-alpha olefin copolymer as elastomeric modifier (B) in the present invention preferably has a melt flow rate MFR₂ (190° C.) of at least 10.0 g/10 min, preferably in the range of 12.0 g/10 min to 200.0 g/10 min, more preferably in the range of 15.0 to 150.0 g/10 min.

In case the suitable elastomeric modifier (B) exhibits crystallinity, the melting points (Tₘ) are in the range of 55 to 110° C., preferably in the range of 60 to 105° C., more preferably in the range of 65 to 100° C.

Furthermore a suitable elastomeric modifier (B) has at least one glass transition temperature T_{g} (measured with DMTA according to ISO 6721-7) of equal to or below −15° C., preferably in the range of −65 to −20° C., more preferably in the range of −60 to −25° C.

In case the elastomeric modifier (B) is a copolymer of ethylene and a C4-C10 alpha olefin it preferably has an ethylene content from 50 to 95 wt %, preferably from 55 to 90 wt % and more preferably from 60 to 85 wt %.

The molecular weight distribution Mw/Mn is most often below 4.0, such as 3.8 or below, but is at least 1.7. It is preferably between 3.5 and 1.8.

An ethylene-alpha olefin copolymer as elastomeric modifier (B) suitable for the current invention being a copolymer of ethylene and a C4-C10 alpha olefin is commercially available, i.a. from Borealis AG (AT) under the trade name Queo, from DOW Chemical Corp (USA) under the trade name Engage or Affinity, or from Mitsui under the trade name Tafmer.

In case the elastomeric modifier (B) is a copolymer of ethylene and propylene it preferably has an ethylene content from 6 to 25 wt %, preferably from 8 to 20 wt % and more preferably from 10 to 15 wt %. Suitable elastomeric copolymers of ethylene and propylene are further characterised by a Shore A hardness determined in accordance with ASTM D2240 of not more than 95, preferably of not more than 90. Such elastomeric copolymers of ethylene and propylene are commercially available, i.a. from DOW Chemical Corp (USA) under the trade name Versify or from ExxonMobil (USA) under the trade name Vistamaxx.

Alternately the ethylene-alpha olefin copolymer as elastomeric modifier (B) can be prepared by known processes, in a one stage or two stage polymerization process, comprising solution polymerization, slurry polymerization, gas phase polymerization or combinations therefrom, in the presence of suitable catalysts, like vanadium oxide catalysts or single-site catalysts, e.g. metallocene or constrained geometry catalysts, known to the art skilled persons.

Preferably the ethylene-alpha olefin copolymer as elastomeric modifier (B) is prepared by a one stage or two stage solution polymerization process, especially by high temperature solution polymerization process at temperatures higher than 100° C.

Such process is essentially based on polymerizing the monomer and a suitable comonomer in a liquid hydrocarbon solvent in which the resulting polymer is soluble. The polymerization is carried out at a temperature above the melting point of the polymer, as a result of which a polymer solution is obtained. This solution is flashed in order to separate the polymer from the unreacted monomer and the solvent. The solvent is then recovered and recycled in the process.

Preferably the solution polymerization process is a high temperature solution polymerization process, using a polymerization temperature of higher than 100° C. Preferably the polymerization temperature is at least 110° C., more preferably at least 150° C. The polymerization temperature can be up to 250° C.

The pressure in such a solution polymerization process is preferably in a range of 10 to 100 bar, preferably 15 to 100 bar and more preferably 20 to 100 bar.

The liquid hydrocarbon solvent used is preferably a C5-12-hydrocarbon which may be unsubstituted or substituted by C1-4 alkyl group such as pentane, methyl pentane, hexane, heptane, octane, cyclohexane, methylcyclohexane and hydrogenated naphtha. More preferably unsubstituted C6-C0-hydrocarbon solvents are used.

A known solution technology suitable for the process according to the invention is the COMPACT technology.

### Polymer Composition

In a preferred embodiment according to the present invention, the polymer composition is partially crystallized in the ß-modification. Thus it is preferred that the amount of β-modification of the polymer composition is at least 60%, more preferably at least 70%, still more preferably at least 75%, yet more preferably at least 78%, (determined by DSC using the second heat as described in detail in the example section).

In a specifically preferred embodiment, the polymer composition according to this invention has a first melting temperature (Tm₁) measured according to ISO 11357-3 of not higher than 145° C., preferably in the range of 115 to 145° C., more preferably in the range of 120 to 144° C., still more preferably in the range of 122-142° C., like in the range of 120-140° C.; and has a second melting temperature (Tm₂) measured according to ISO 11357-3 of not higher than 135° C., preferably in the range of 105 to 132° C., more preferably in the range of 110 to 130° C.

The polymer composition according to this invention preferably has a MFR₂ measured according to ISO 1133 (230° C., 2.16 kg load) in the range of 0.8 to 25.0 g/10 min, preferably 1.2 to 20.0 g/10 min and more preferably 1.8 to 17.0 g/10 min.

Furthermore, it is preferred that the polymer composition has a certain improvement regarding to the impact strength, in comparison to the non-β-nucleated polymer composition. Accordingly, the impact strength of the polymer composition according to the Charpy notched impact strength test ISO 179 1 eA at +23° C. is preferably at least 8.0 kJ/m², preferably in the range of 8.5 to 90 kJ/m², more preferably in the range of 9.0 to 80 kJ/m².

In a further preferred embodiment, the impact strength of the polymer composition of the present invention is at least 50%, preferably 60% to 600%, more preferably 65% to 650% higher than impact strength of the non-nucleated polymer composition.

Furthermore, the polymer composition of the present invention preferably shows a tensile modulus measured according to ISO 527-1 at +23° C. in the range of 400-1000 MPa, preferably in the range of 450-950 MPa, more preferably in the range of 470-930 MPa.

The polymer composition according to the invention may contain usual auxiliary materials, e. g. up to 10 wt % fillers and/or 0.01 to 2.5 wt % stabilizers and/or 0.01 to 1 wt % processing aids and/or 0.1 to 1 wt % antistatic agents and/or 0.2 to 3 wt % pigments and/or reinforcing agents, e. g. glass fibres, in each case based on the terpolymer (A) used (the wt % given in this paragraph refer to the total amount of the polymer composition). In this respect, it has to be noted, however, that any of such auxiliary materials which serve as highly active α-nucleating agents, such as certain pigments, are not utilized in accordance with the present invention.

### Polymerization Process

The present invention is not only directed to the instant propylene copolymer, but also directed to the polymerization process for producing the terpolymer of propylene, ethylene and one C4 to C10 α-olefin (αO) described above.

It is preferred that the terpolymer(A) as defined above is produced in the presence of the catalyst as defined below. Furthermore, for the production of terpolymer (A) as defined above, the process as stated below is preferably used.

Thus the manufacture of the nucleated terpolymer (A) comprises the steps of:

(a) producing a terpolymer (A) as defined herein, and subsequently
(b) treating the terpolymer (A) with a β-nucleating agent, preferably at temperatures in the range of 175 to 300° C., and
(c) cooling and crystallizing the terpolymer (A) composition.

In the following the process will be described in more detail.

Preferably the terpolymer (A) is produced in the presence of a Ziegler-Natta catalyst, in particular in the presence of a Ziegler-Natta catalyst capable of catalyzing polymerization of propylene at a pressure of 10 to 100 bar, in particular 25 to 80 bar, and at a temperature of 40 to 110° C., in particular of 60 to 100° C.

In a specifically preferred embodiment of the present invention, a specific Ziegler-Natta catalyst is preferably used.

The catalyst used in the specific embodiment is a solid Ziegler-Natta catalyst, which comprises compounds of a transition metal of Group 4 to 6 of IUPAC, like titanium, a Group 2 metal compound, like a magnesium, and an internal donor being preferably a non-phthalic compound, more preferably a non-phthalic acid ester, still more preferably being a diester of non-phthalic dicarboxylic acids as described in more detail below. Thus, the catalyst is fully free of undesired phthalic compounds. Further, the solid catalyst is free of any external support material, like silica or MgCl₂, but the catalyst is self-supported.

The Ziegler-Natta catalyst (ZN-C) can be further defined by the way as obtained.

Accordingly, the Ziegler-Natta catalyst (ZN-C) is preferably obtained by a process comprising the steps of

a)
a₁) providing a solution of at least a Group 2 metal alkoxy compound (Ax) being the reaction product of a Group 2 metal compound and a monohydric alcohol (A) comprising in addition to the hydroxyl moiety at least one ether moiety optionally in an organic liquid reaction medium; or
a₂) a solution of at least a Group 2 metal alkoxy compound (Ax′) being the reaction product of a Group 2 metal compound and an alcohol mixture of the monohydric alcohol (A) and a monohydric alcohol (B) of formula ROH, optionally in an organic liquid reaction medium; or
a₃) providing a solution of a mixture of the Group 2 alkoxy compound (Ax) and a Group 2 metal alkoxy compound (Bx) being the reaction product of a Group 2 metal compound and the monohydric alcohol (B), optionally in an organic liquid reaction medium; or
a₄) providing a solution of Group 2 alkoxide of formula M(OR₁)ₙ(OR₂)ₘX₂₋ₙ₋ₘ or mixture of Group 2 alkoxides M(OR₁)_{n′}X_{2-n′} and M(OR₂)_{m′}X_{2-m′}, where M is Group 2 metal, X is halogen, R₁ and R₂ are different alkyl groups of C₂ to C₁₆ carbon atoms, and 0≤n<2, 0≤m<2 and n+m+(2−n−m)=2, provided that both n and m≠0, 0<n′≤2 and 0<m′≤2; and
b) adding said solution from step a) to at least one compound of a transition metal of Group 4 to 6 and
c) obtaining the solid catalyst component particles,
and adding an internal electron donor, preferably a non-phthalic internal donor, at any step prior to step c).

The internal donor or precursor thereof is added preferably to the solution of step a).

According to the procedure above the Ziegler-Natta catalyst can be obtained via precipitation method or via emulsion (liquid/liquid two-phase system)—solidification method depending on the physical conditions, especially temperature used in steps b) and c).

In both methods (precipitation or emulsion-solidification) the catalyst chemistry is the same.

In precipitation method combination of the solution of step a) with at least one transition metal compound in step b) is carried out and the whole reaction mixture is kept at least at 50° C., more preferably in the temperature range of 55° C. to 110° C., more preferably in the range of 70° C. to 100° C., to secure full precipitation of the catalyst component in form of a solid particles (step c).

In emulsion—solidification method in step b) the solution of step a) is typically added to the at least one transition metal compound at a lower temperature, such as from −10 to below 50° C., preferably from −5 to 30° C. During agitation of the emulsion the temperature is typically kept at −10 to below 40° C., preferably from −5 to 30° C. Droplets of the dispersed phase of the emulsion form the active catalyst composition.

Solidification (step c) of the droplets is suitably carried out by heating the emulsion to a temperature of 70 to 150° C., preferably to 80 to 110° C.

The catalyst prepared by emulsion—solidification method is preferably used in the present invention.

In a preferred embodiment in step a) the solution of a₂) or a₃) are used, i.e. a solution of (Ax′) or a solution of a mixture of (Ax) and (Bx).

Preferably the Group 2 metal is magnesium.

The magnesium alkoxy compounds (Ax), (Ax′) and (Bx) can be prepared in situ in the first step of the catalyst preparation process, step a), by reacting the magnesium compound with the alcohol(s) as described above, or said magnesium alkoxy compounds can be separately prepared magnesium alkoxy compounds or they can be even commercially available as ready magnesium alkoxy compounds and used as such in the catalyst preparation process of the invention.

Illustrative examples of alcohols (A) are monoethers of dihydric alcohols (glycol monoethers). Preferred alcohols (A) are C₂ to C₄ glycol monoethers, wherein the ether moieties comprise from 2 to 18 carbon atoms, preferably from 4 to 12 carbon atoms. Preferred examples are 2-(2-ethylhexyloxy)ethanol, 2-butyloxy ethanol, 2-hexyloxy ethanol and 1,3-propylene-glycol-monobutyl ether, 3-butoxy-2-propanol, with 2-(2-ethylhexyloxy)ethanol and 1,3-propylene-glycol-monobutyl ether, 3-butoxy-2-propanol being particularly preferred.

Illustrative monohydric alcohols (B) are of formula ROH, with R being straight-chain or branched C₆-C₁₀ alkyl residue. The most preferred monohydric alcohol is 2-ethyl-1-hexanol or octanol.

Preferably a mixture of Mg alkoxy compounds (Ax) and (Bx) or mixture of alcohols (A) and (B), respectively, are used and employed in a mole ratio of Bx:Ax or B:A from 8:1 to 2:1, more preferably 5:1 to 3:1.

Magnesium alkoxy compound may be a reaction product of alcohol(s), as defined above, and a magnesium compound selected from dialkyl magnesiums, alkyl magnesium alkoxides, magnesium dialkoxides, alkoxy magnesium halides and alkyl magnesium halides. Alkyl groups can be a similar or different C₁-C₂₀ alkyl, preferably C₂-C₁₀ alkyl. Typical alkyl-alkoxy magnesium compounds, when used, are ethyl magnesium butoxide, butyl magnesium pentoxide, octyl magnesium butoxide and octyl magnesium octoxide. Preferably the dialkyl magnesiums are used. Most preferred dialkyl magnesiums are butyl octyl magnesium or butyl ethyl magnesium.

It is also possible that magnesium compound can react in addition to the alcohol (A) and alcohol (B) also with a polyhydric alcohol (C) of formula R″(OH)ₘ to obtain said magnesium alkoxide compounds. Preferred polyhydric alcohols, if used, are alcohols, wherein R″ is a straight-chain, cyclic or branched C₂ to C₁₀ hydrocarbon residue, and m is an integer of 2 to 6.

The magnesium alkoxy compounds of step a) are thus selected from the group consisting of magnesium dialkoxides, diaryloxy magnesiums, alkyloxy magnesium halides, aryloxy magnesium halides, alkyl magnesium alkoxides, aryl magnesium alkoxides and alkyl magnesium aryloxides. In addition a mixture of magnesium dihalide and a magnesium dialkoxide can be used.

The solvents to be employed for the preparation of the present catalyst may be selected among aromatic and aliphatic straight chain, branched and cyclic hydrocarbons with 5 to 20 carbon atoms, more preferably 5 to 12 carbon atoms, or mixtures thereof. Suitable solvents include benzene, toluene, cumene, xylol, pentane, hexane, heptane, octane and nonane. Hexanes and pentanes are particular preferred.

Mg compound is typically provided as a 10 to 50 wt % solution in a solvent as indicated above. Typical commercially available Mg compound, especially dialkyl magnesium solutions are 20-40 wt % solutions in toluene or heptanes.

The reaction for the preparation of the magnesium alkoxy compound may be carried out at a temperature of 40° C. to 70° C. Most suitable temperature is selected depending on the Mg compound and alcohol(s) used.

The transition metal compound of Group 4 to 6 is preferably a titanium compound, most preferably a titanium halide, like TiCl₄.

The non-phthalic internal donor used in the preparation of the catalyst used in the present invention is preferably selected from (di)esters of non-phthalic carboxylic (di)acids, 1,3-diethers, derivatives and mixtures thereof. Especially preferred donors are diesters of mono-unsaturated dicarboxylic acids, in particular esters belonging to a group comprising malonates, maleates, succinates, citraconates, glutarates, cyclohexene-1,2-dicarboxylates and benzoates, and any derivatives and/or mixtures thereof. Preferred examples are e.g. substituted maleates and citraconates, most preferably citraconates.

In emulsion method, the two phase liquid-liquid system may be formed by simple stirring and optionally adding (further) solvent(s) and additives, such as the turbulence minimizing agent (TMA) and/or the emulsifying agents and/or emulsion stabilizers, like surfactants, which are used in a manner known in the art for facilitating the formation of and/or stabilize the emulsion. Preferably, surfactants are acrylic or methacrylic polymers. Particular preferred are unbranched C₁₂ to C₂₀ (meth)acrylates such as poly(hexadecyl)-methacrylate and poly(octadecyl)-methacrylate and mixtures thereof. Turbulence minimizing agent (TMA), if used, is preferably selected from α-olefin polymers of α-olefin monomers with 6 to 20 carbon atoms, like polyoctene, polynonene, polydecene, polyundecene or polydodecene or mixtures thereof. Most preferable it is polydecene.

The solid particulate product obtained by precipitation or emulsion—solidification method may be washed at least once, preferably at least twice, most preferably at least three times with an aromatic and/or aliphatic hydrocarbons, preferably with toluene, heptane or pentane. The catalyst can further be dried, as by evaporation or flushing with nitrogen, or it can be slurried to an oily liquid without any drying step.

The finally obtained Ziegler-Natta catalyst is desirably in the form of particles having generally an average particle size range of 5 to 200 μm, preferably 10 to 100. Particles are compact with low porosity and have surface area below 20 g/m², more preferably below 10 g/m². Typically the amount of Ti is 1 to 6 wt %, Mg 10 to 20 wt % and donor 10 to 40 wt % of the catalyst composition.

Detailed description of preparation of catalysts is disclosed in WO 2012/007430, EP 2610271, EP 261027 and EP 2610272 which are incorporated here by reference.

The Ziegler-Natta catalyst is preferably used in association with an alkyl aluminum cocatalyst and optionally external donors.

As further component in the instant polymerization process an external donor is preferably present. Suitable external donors include certain silanes, ethers, esters, amines, ketones, heterocyclic compounds and blends of these. It is especially preferred to use a silane. It is most preferred to use silanes of the general formula

R^{a}ₚR^{b}_{q}Si(OR^{c})_{(4-p-q)}

wherein R^{a}, R^{b} and R^{c} denote a hydrocarbon radical, in particular an alkyl or cycloalkyl group, and wherein p and q are numbers ranging from 0 to 3 with their sum p+q being equal to or less than 3. R^{a}, R^{b} and R^{c} can be chosen independently from one another and can be the same or different. Specific examples of such silanes are (tert-butyl)₂Si(OCH₃)₂, (cyclohexyl)(methyl)Si(OCH₃)₂, (phenyl)₂Si(OCH₃)₂ and (cyclopentyl)₂Si(OCH₃)₂, or of general formula

Si(OCH₂CH₃)₃(NR³R⁴)

wherein R³ and R⁴ can be the same or different a represent a hydrocarbon group having 1 to 12 carbon atoms.
R³ and R⁴ are independently selected from the group consisting of linear aliphatic hydrocarbon group having 1 to 12 carbon atoms, branched aliphatic hydrocarbon group having 1 to 12 carbon atoms and cyclic aliphatic hydrocarbon group having 1 to 12 carbon atoms. It is in particular preferred that R³ and R⁴ are independently selected from the group consisting of methyl, ethyl, n-propyl, n-butyl, octyl, decanyl, iso-propyl, iso-butyl, iso-pentyl, tert.-butyl, tert.-amyl, neopentyl, cyclopentyl, cyclohexyl, methylcyclopentyl and cycloheptyl.

More preferably both R³ and R⁴ are the same, yet more preferably both R³ and R⁴ are an ethyl group.

Especially preferred external donors are the dicyclopentyl dimethoxy silane donor (D-donor) or the cyclohexylmethyl dimethoxy silane donor (C-Donor).

In addition to the Ziegler-Natta catalyst and the optional external donor a co-catalyst can be used. The co-catalyst is preferably a compound of group 13 of the periodic table (IUPAC), e.g. organo aluminum, such as an aluminum compound, like aluminum alkyl, aluminum halide or aluminum alkyl halide compound. Accordingly, in one specific embodiment the co-catalyst is a trialkylaluminium, like triethylaluminium (TEAL), dialkyl aluminium chloride or alkyl aluminium dichloride or mixtures thereof. In one specific embodiment the co-catalyst is triethylaluminium (TEAL).

Preferably the ratio between the co-catalyst (Co) and the external donor (ED) [Co/ED] and/or the ratio between the co-catalyst (Co) and the transition metal (TM) [Co/TM] should be carefully chosen.

Accordingly,
(a) the mol-ratio of co-catalyst (Co) to external donor (ED) [Co/ED] must be in the range of 5 to 45, preferably is in the range of 5 to 35, more preferably is in the range of 5 to 25; and optionally
(b) the mol-ratio of co-catalyst (Co) to titanium compound (TC) [Co/TC] must be in the range of above 80 to 500, preferably is in the range of 100 to 350, still more preferably is in the range of 120 to 300.

According to a further preferred embodiment, the terpolymer (A) according to this invention is produced in a polymerization process, preferably in the presence of

(a) a Ziegler-Natta catalyst comprising compounds (TC) of a transition metal of Group 4 to 6 of IUPAC, a Group 2 metal compound (MC) and an internal donor (ID), wherein said internal donor (ID) is a non-phthalic compound, preferably is a non-phthalic acid ester and still more preferably is a diester of non-phthalic dicarboxylic acids;
(b) optionally a co-catalyst (Co), and
(c) optionally an external donor (ED).

It is preferred that the internal donor (ID) is selected from malonates, maleates, succinates, glutarates, cyclohexene-1,2-dicarboxylates, benzoates, and derivatives and/or mixtures thereof, preferably the internal donor (ID) is a citraconate. Additionally or alternatively, the molar-ratio of co-catalyst (Co) to external donor (ED) [Co/ED] is 5 to 45.

The equipment of the polymerization process can comprise any polymerization reactors of conventional design for producing terpolymer (A). For the purpose of the present invention “slurry reactor” designates any reactor, such as a continuous or simple batch stirred tank reactor or loop reactor, operating in bulk or slurry and in which the polymer forms in particulate form. “Bulk” means a polymerization in reaction medium that comprises at least 60 wt % monomer. According to a preferred embodiment the slurry reactor comprises (is) a bulk loop reactor. By “gas phase reactor” is meant any mechanically mixed or fluid bed reactor. Preferably the gas phase reactor comprises a mechanically agitated fluid bed reactor with gas velocities of at least 0.2 m/sec.

Thus, the polymerization reactor system can comprise one or more conventional stirred tank slurry reactors, as described in WO 94/26794, and/or one or more gas phase reactors.

Preferably the reactors used are selected from the group of loop and gas phase reactors and, in particular, the process employs at least one loop reactor and at least one gas phase reactor. This alternative is particularly suitable for producing the terpolymer (A) with a broad molecular weight distribution (MWD) according to this invention. By carrying out the polymerization in the different polymerization reactors in the presence of different amounts of hydrogen the MWD of the product can be broadened and its mechanical properties improved. It is also possible to use several reactors of each type, e.g. one loop reactor and two or three gas phase reactors or two loop reactors and one gas phase reactor, in series.

In addition to the actual polymerization reactors used for producing the terpolymer (A) the polymerization reaction system can also include a number of additional reactors, such as pre- and/or post-reactors. The pre-reactors include any reactor for pre-polymerizing the catalyst with propylene. The post-reactors include reactors used for modifying and improving the properties of the polymer product.

All reactors of the reactor system are preferably arranged in series.

The gas phase reactor can be an ordinary fluidized bed reactor, although other types of gas phase reactors can be used. In a fluidized bed reactor, the bed consists of the formed and growing polymer particles as well as still active catalyst come along with the polymer fraction. The bed is kept in a fluidized state by introducing gaseous components, for instance monomer on such flowing rate which will make the particles act as a fluid. The fluidizing gas can contain also inert carrier gases, like nitrogen and also hydrogen as a modifier. The fluidized gas phase reactor can be equipped with a mechanical mixer.

The gas phase reactor used can be operated in the temperature range of 50 to 115° C., preferably between 60 and 110° C. and the reaction pressure between 5 and 50 bar and the partial pressure of monomer between 2 and 45 bar.

The pressure of the effluent, i.e. the polymerization product including the gaseous reaction medium, can be released after the gas phase reactor in order optionally to separate part of the gaseous and possible volatile components of the product, e.g. in a flash tank. The overhead stream or part of it is re-circulated to the reactor.

After the polymerization the terpolymer (A) is blended with the β-nucleating agent as defined above, and optionally with the elastomeric modifier (B) to obtain the polymer composition. The mixing can be carried out by methods known per se, e.g. by mixing the propylene copolymer (A) with the β-nucleating in the desired weight relationship using a batch or a continuous process. As examples of typical batch mixers the Banbury and the heated roll mill can be mentioned. Continuous mixers are exemplified by the Farrel mixer, the Buss co-kneader, and single- or twin-screw extruders.

The present invention is also directed to article comprising the polymer composition, preferably moulded article, more preferably blow moulded or injection moulded articles, comprising the polymer composition.

The following examples serve to further illustrate the present invention without limiting it.

### EXAMPLES

### 1. Measuring Methods

The following definitions of terms and determination methods apply for the above general description of the invention as well as to the below examples unless otherwise defined.

MFR₂ (230° C.) of propylene terpolymer (A) and composition is measured according to ISO 1133 (230° C., 2.16 kg load).

MFR₂ (190° C.) of the Elastomeric modifiers (B) is measured according to ISO 1133 (190° C., 2.16 kg load).

The xylene solubles (XCS, wt %): Content of xylene cold solubles (XCS) is determined at 25° C. according ISO 16152; first edition; 2005 Jul. 2001

### Microstructure Quantification by NMR Spectroscopy

Quantitative nuclear-magnetic resonance (NMR) spectroscopy was used to quantify the comonomer content of the polymers.

### Comonomer Content in Poly(Propylene-Co-Ethylene-Co-Butene) Terpolymers

Quantitative 13C{1H} NMR spectra recorded in the molten-state using a Bruker Advance III 500 NMR spectrometer operating at 500.13 and 125.76 MHz for 1H and 13C respectively. All spectra were recorded using a 13C optimised 7 mm magic-angle spinning (MAS) probehead at 180° C. using nitrogen gas for all pneumatics. Approximately 200 mg of material was packed into a 7 mm outer diameter zirconia MAS rotor and spun at 4.5 kHz. This setup was chosen primarily for the high sensitivity needed for rapid identification and accurate quantification.{klimke06, parkinson07, castignolles09} Standard single-pulse excitation was employed utilising the NOE at short recycle delays{pollard04, klimke06} and the RS-HEPT decoupling scheme{fillip05,griffin07}. A total of 1024 (1k) transients were acquired per spectra.

Quantitative 13C{1H} NMR spectra were processed, integrated and relevant quantitative properties determined from the integrals. All chemical shifts are internally referenced to the methyl isotactic pentad (mmmm) at 21.85 ppm.

Characteristic signals corresponding to regio defects were not observed {resconi00}. The amount of propene was quantified based on the main Sααmethylene sites at 44.1 ppm:

Ptotal=I_{Sαα}

Characteristic signals corresponding to the incorporation of 1-butene were observed and the comonomer content quantified in the following way. The amount isolated 1-butene incorporated in PPBPP sequences was quantified using the integral of the αB2 sites at 44.1 ppm accounting for the number of reporting sites per comonomer:

B=I_{αB2}/2

The amount consecutively incorporated 1-butene in PPBBPP sequences was quantified using the integral of the ααB2 site at 40.5 ppm accounting for the number of reporting sites per comonomer:

BB=2*I_{ααB2}

The total 1-butene content was calculated based on the sum of isolated and consecutively incorporated 1-butene:

Btotal=B+BB

The total mole fraction of 1-butene in the polymer was then calculated as:

fB=(Btotal/(Etotal+Ptotal+Btotal)

Characteristic signals corresponding to the incorporation of ethylene were observed and the comonomer content quantified in the following way. The amount isolated ethylene incorporated in PPEPP sequences was quantified using the integral of the Sαγ sites at 37.9 ppm accounting for the number of reporting sites per comonomer:

E=I_{Sαγ}/2

With no sites indicative of consecutive incorporation observed the total ethylene comonomer content was calculated solely on this quantity:

Etotal=E

The total mole fraction of ethylene in the polymer was then calculated as:

fE=(Etotal/(Etotal+Ptotal+Btotal)

The mole percent comonomer incorporation was calculated from the mole fractions:

B[mol %]=100*fB

E[mol %]=100*fE

The weight percent comonomer incorporation was calculated from the mole fractions:

klimke06

Klimke, K., Parkinson, M., Piel, C., Kaminsky, W., Spiess, H. W., Wilhelm, M., Macromol. Chem. Phys. 2006; 207:382.

parkinson07

Parkinson, M., Klimke, K., Spiess, H. W., Wilhelm, M., Macromol. Chem. Phys. 2007; 208:2128.

pollard04

Pollard, M., Klimke, K., Graf, R., Spiess, H. W., Wilhelm, M., Sperber, O., Piel, C., Kaminsky, W., Macromolecules 2004; 37:813.

filip05

Filip, X., Tripon, C., Filip, C., J. Mag. Resn. 2005, 176, 239

griffin07

Griffin, J. M., Tripon, C., Samoson, A., Filip, C., and Brown, S. P., Mag. Res. in Chem. 2007 45, S1, S198

castignolles09

Castignolles, P., Graf, R., Parkinson, M., Wilhelm, M., Gaborieau, M., Polymer 50 (2009) 2373

busico01

Busico, V., Cipullo, R., Prog. Polym. Sci. 26 (2001) 443

busico97

Busico, V., Cipullo, R., Monaco, G., Vacatello, M., Segre, A. L., Macromoleucles 30 (1997) 6251

zhou07

Zhou, Z., Kuemmerle, R., Qiu, X., Redwine, D., Cong, R., Taha, A., Baugh, D. Winniford, B., J. Mag. Reson. 187 (2007) 225

busico07

Busico, V., Carbonniere, P., Cipullo, R., Pellecchia, R., Severn, J., Talarico, G., Macromol. Rapid Commun. 2007, 28, 1128

resconi00

Resconi, L., Cavallo, L., Fait, A., Piemontesi, F., Chem. Rev. 2000, 100, 1253

### Content of β-Modification:

The β-crystallinity is determined by Differential Scanning calorimetry (DSC). DSC is run according to ISO 3146/part 3/method C2 with a scan rate of 10° C./min. The amount of ß-modification is calculated from the second heat by the following formula: β−area/α−area+β−area

Since the thermodynamical β-modification starts to be changed into the more stable α-modification at temperatures above 150° C., a part of the β-modification is transferred within the heating process of DSC-measurement. Therefore, the amount of ß-PP determined by DSC is lower as when measured according to the method of Turner-Jones by WAXS (A. Turner-Jones et. al., Makromol. Chem 75 (1964) 134). “Second heat” means that the sample is heated according to ISO 3146/part 3/method C2 for a first time and then cooled to room temperature at a rate of 10° C./min. The sample is then heated a second time, also according to ISO 3146/part 3/method C2. This second heat is relevant for measurement and calculation.

During the “first heat” all thermal history of the sample giving rise to different crystalline structure, which typically comes from different processing conditions and/or methods, is destroyed. Using the second heat for determination of β-crystallinity, it is possible to compare samples regardless of the way the samples were originally manufactured.

Number average molecular weight (Mₐ), weight average molecular weight (M_{w}) and molecular weight distribution (Mw/Mn) are determined by Gel Permeation Chromatography (GPC) according to the following method:

The weight average molecular weight Mw and the molecular weight distribution (Mw/Mn), wherein Mn is the number average molecular weight and Mw is the weight average molecular weight) is measured by a method based on ISO 16014-1:2003 and ISO 16014-4:2003. A Waters Alliance GPCV 2000 instrument, equipped with refractive index detector and online viscosimeter was used with 3×TSK-gel columns (GMHXL-HT) from TosoHaas and 1,2,4-trichlorobenzene (TCB, stabilized with 200 mg/L 2,6-Di tert butyl-4-methyl-phenol) as solvent at 145° C. and at a constant flow rate of 1 mL/min. 216.5 μL of sample solution were injected per analysis. The column set was calibrated using relative calibration with 19 narrow MWD polystyrene (PS) standards in the range of 0.5 kg/mol to 11 500 kg/mol and a set of well characterized broad polypropylene standards. All samples were prepared by dissolving 5-10 mg of polymer in 10 mL (at 160° C.) of stabilized TCB (same as mobile phase) and keeping for 3 hours with continuous shaking prior sampling in into the GPC instrument.

Density is determined according to ISO1183D and ISO1872-2 for sample preparation.

Melting temperature (Tm) and enthalpy (Hf), crystallization temperature (Tc) and enthalpy (Hc): are measured by the DSC method according to ISO 11357-3. For Tm the peak temperature in the second heat in a heat—cool—heat cycle with a rate of 10 K/min between ambient temperature and 210° C. has been used.

The glass transition temperature T_{g} is determined by dynamic mechanical analysis according to ISO 6721-7. The measurements are done in torsion mode on compression moulded samples (40×10×1 mm3) between −100° C. and +150° C. with a heating rate of 2° C./min and a frequency of 1 Hz.

Tensile test: The tensile test (modulus, strength and extension at break) is measured at 23° C. according to ISO 527-1 (cross head speed 1 mm/min) using injection moulded specimens according to ISO 527-2(1B), produced according to EN ISO 1873-2 (dog bone shape, 4 mm thickness)

Charpy impact test: The Charpy notched impact strength (NIS) was measured according to ISO 179 1 eA at +23° C. and −20° C., using injection moulded bar test specimens of 80×10×4 mm³ prepared in accordance with EN ISO 1873-22.

### Material Description

### Catalyst for Examples

The catalyst used in the polymerization process for terpolymers of both the inventive examples (IE1-3) and comparative examples (CE1-3) was prepared as follows:

### Used Chemicals:

20% solution in toluene of butyl ethyl magnesium (Mg(Bu)(Et), BEM), provided by Chemtura

2-ethylhexanol, provided by Amphochem

3-Butoxy-2-propanol—(DOWANOL™ PnB), provided by Dow

bis(2-ethylhexyl)citraconate, provided by SynphaBase

TiCl₄, provided by Millenium Chemicals

Toluene, provided by Aspokem

Viscoplex® 1-254, provided by Evonik

Heptane, provided by Chevron

### Preparation of the Mg Alkoxy Compound:

Mg alkoxide solution was prepared by adding, with stirring (70 rpm), into 11 kg of a 20 wt % solution in toluene of butyl ethyl magnesium (Mg(Bu)(Et)), a mixture of 4.7 kg of 2-ethylhexanol and 1.2 kg of butoxypropanol in a 20 l stainless steel reactor. During the addition the reactor contents were maintained below 45° C. After addition was completed, mixing (70 rpm) of the reaction mixture was continued at 60° C. for 30 minutes. After cooling to room temperature 2.3 kg g of the donor bis(2-ethylhexyl)citraconate was added to the Mg-alkoxide solution keeping temperature below 25° C. Mixing was continued for 15 minutes under stirring (70 rpm).

### Preparation of Solid Catalyst Component

20.3 kg of TiCl₄ and 1.1 kg of toluene were added into a 20 l stainless steel reactor. Under 350 rpm mixing and keeping the temperature at 0° C., 14.5 kg of the Mg alkoxy compound prepared in example 1 was added during 1.5 hours. 1.7 l of Viscoplex® 1-254 and 7.5 kg of heptane were added and after 1 hour mixing at 0° C. the temperature of the formed emulsion was raised to 90° C. within 1 hour. After 30 minutes mixing was stopped catalyst droplets were solidified and the formed catalyst particles were allowed to settle. After settling (1 hour), the supernatant liquid was siphoned away. Then the catalyst particles were washed with 45 kg of toluene at 90° C. for 20 minutes followed by two heptane washes (30 kg, 15 min). During the first heptane wash the temperature was decreased to 50° C. and during the second wash to room temperature.

The thus obtained catalyst was used along with triethyl-aluminium (TEAL) as co-catalyst and di(cyclopentyl) dimethoxy silane (D-donor) as donor.

### Terpolymer (A):

The terpolymer (A) used in the inventive examples IE1, and comparative example CE1 is named TP1, which is a terpolymer of propylene (C3), ethylene (C2) and 1-butene (C4) produced in the presence of the catalyst described above. Said terpolymer TP1 has a C2 content of 1.0 wt %, a C4 content of 9.0 wt %, and a MFR₂ (230° C.) of 1.9 g/10 min. The molecular weight distribution (MWD) as determined by gel permeation chromatography (GPC) has a weight average M_{w} of 585 kg/mol and a broadness M_{w}/Mₙ of 5.8.

The terpolymer (A) used in the inventive examples IE2 and comparative example CE2 is named TP2, which is a terpolymer of propylene (C3), ethylene (C2) and 1-butene (C4) produced in the presence of the catalyst described above. Said terpolymer TP2 has a C2 content of 1.0 wt %, a C4 content of 8.9 wt %, and a MFR₂ (230° C.) of 7.1 g/10 min. The MWD as determined by GPC has a weight average M_{w} of 402 kg/mol and a broadness M_{w}/Mₙ of 5.6.

### β-Nucleating Agent:

CGNA-7588 (distributed by BASF) is used as β-nucleating agent in inventive examples.

### Elastomeric Modifier (B):

Elastomeric modifier EM1 is a commercial ethylene based octene plastomer Queo™ 8230 available from Borealis AG, produced in a solution polymerization process using a metallocene catalyst with MFR₂ (190° C., 2.16 kg) of 30 g/10 min, a density of 0.882 g/cm³ and a melting point of 75° C.

### 3. Examples

Different polymer compositions for the Inventive Examples (IE) and the comparative examples (CE) were made in a Borstar PP pilot plant in the slurry loop reactor only.

The mixing was done on ZSK 57 twin screw extruder at temperature 200° C. Desired amount of polymers were mixed with 0.1 wt % of Pentaerythrityl-tetrakis(3-(3′,5′-di-tert. butyl-4-hydroxyphenyl)-propionate, (CAS-no. 6683-19-8, trade name Irganox 1010) supplied by BASF AG, 0.1 wt % Tris (2,4-di-t-butylphenyl) phosphate (CAS-no. 31570-04-4, trade 10 name Irgafos 168) supplied by BASF AG, and 0.05 wt % of Calcium stearate (CAS-no. 1592-23-0) supplied by Croda and 100 ppm of CGNA-7588. The CE has no β-nucleating agent.

The composition of the Inventive Examples (IE) and the comparative examples (CE) and the mechanical and properties are shown in Table 1.

TABLE 1
Composition and mechanical properties of examples and comparative
examples

| | Examples | | | | | |
|---|---|---|---|---|---|---|
| | IE1* | CE1* | IE2* | CE2* | IE3* | CE3* |
| TP1 [wt %] | 99.84 | 99.85 | | | | |
| TP2 [wt %] | | | 99.84 | 99.85 | 89.84 | 89.85 |
| β-nuceating agent [wt %] | 0.01 | 0 | 0.01 | 0 | 0.01 | 0 |
| EM1 [wt %] | | | | | 10.00 | 10.00 |
| MFR₂ (230° C.) [g/10 min] | 2.0 | 2.0 | 7.1 | 7.1 | 9.1 | 9.0 |
| Tm₁ [° C.] | 135 | 133 | 133 | 131 | 133 | 131 |
| Tm₂ [° C.] | 122 | — | 121 | — | 121 | — |
| Tg [° C.] | −2 | −1.9 | −2 | −2 | −2/−50 | −2/−50 |
| Tc [° C.] | 96 | 95 | 97 | 92 | 97 | 89 |
| β-modification content [%] | 80.7 | — | 80.1 | — | 88.9 | — |
| Tensile modulus [MPa] | 877 | 834 | 754 | 778 | 564 | 575 |
| NIS@23° C. Tm₁ [kJ/m²] | 51.8 | 9.76 | 10.8 | 6.0 | 23.0 | 10.0 |
| ΔNIS@23° C. [%] | 431 | — | 80 | — | 130 | — |

*remaining part up 100 wt % are typical additives like antioxidants.
Tm melting temperature
Tg glass transition temperature
Tc crystallization temperature
NIS Charpy impact strength (notched)

1. A polymer composition comprising a terpolymer (A) of propylene, ethylene and one C4 to C10 α-olefin (αO), wherein:
i) the ethylene content in said terpolymer (A) is in the range of 0.1 to 8.0 wt % based on the total weight of the terpolymer (A),
ii) the C4 to C10 α-olefin (αO) content in said terpolymer (A) is in the range of 0.1 to 16.0 wt % based on the total weight of the terpolymer (A), and
iii) the melt flow rate MFR₂ (230° C.) of the terpolymer (A) measured according to ISO 1133 (230° C., 2.16 kg load) is 0.5 to below 12.0 g/10 min and
iv) the polymer composition comprises a β-nucleating agent.

2. The polymer composition according to claim 1, wherein the terpolymer (A) of propylene, ethylene and one C4 to C10 α-olefin (αO) has a molecular weight distribution (Mw/Mn) of more than 3.0.

3. The polymer composition according to claim 1, wherein the terpolymer (A) of propylene, ethylene and one C4 to C10 α-olefin (αO) has:
a) a melting temperature (Tm) determined by differential scanning calorimetry (DSC) of not higher than 145° C., and/or
b) a glass transition temperature (Tg) determined by dynamic mechanical analysis (DMA) in the range of −12 to +5° C.

4. The polymer composition according to claim 1, wherein the terpolymer (A) of propylene, ethylene and one C4 to C10 α-olefin has a crystallization temperature (Tc) determined by differential scanning calorimetry (DSC) of equal or higher than 90° C.

5. The polymer composition according to claim 1, wherein the composition further comprises an elastomeric modifier (B), and wherein the amount of said elastomeric modifier based on the total weight of polymer composition is in the range of 0-25 wt %.

6. The polymer composition according to claim 5, wherein:
a) the glass transition temperature (Tg) of the elastomeric modifier (B) determined by dynamic mechanical analysis (DMA) is equal to or below −15° C., and/or
b) the melting temperature (Tm) of the elastomeric modifier (B) determined by differential scanning calorimetry (DSC) is in the range of 55−110° C.

7. The polymer composition according to claim 5, wherein:
a) the melt flow rate MFR₂ (190° C.) of the elastomeric modifier (B) is higher than 10.0 g/10 min, and/or
b) the density of the elastomeric modifier (B) is in the range of 0.850-0.890 g/cm³.

8. The polymer composition according to claim 1, wherein the polymer composition is partially crystallized in the β-modification, and the amount of the β-modification of the terpolymer (A) determined by Differential Scanning calorimetry (DSC) is at least 60.0%.

9. The polymer composition according to claim 1, wherein the impact strength or the polymer composition measured according the Charpy impact test at 23° C. is at least 50% higher than the impact strength of the non-nucleated polymer composition.

10. The polymer composition according to claim 1, wherein the tensile modulus measured according to ISO 527-1 at +23° C. or the polymer composition is in the range of 400 to 1000 MPa.

11. A process for producing the nucleated terpolymer (A) of propylene, ethylene and one C4 to C10 α-olefin (αO), comprising the steps of:
a) producing a terpolymer (A) of propylene, ethylene and one C4 to C10 α-olefin (αO) in a polymerization process in the presence of a Ziegler Natta catalyst (ZN-C), and subsequently,
b) treating the terpolymer (A) with a β-nucleating agent, and
c) cooling and crystallizing the terpolymer (A) composition.

12. The polymerization process for producing the terpolymer (A) of propylene, ethylene and one C4 to C10 α-olefin (αO) according to claim 11, wherein the polymerization process is in the presence of:
a) a Ziegler-Natta catalyst (ZN-C) comprising compounds (TC) of a transition metal of Group 4 to 6 of IUPAC, a Group 2 metal compound (MC) and an internal donor (ID), wherein said internal donor (ID) is a non-phthalic compound,
b) a co-catalyst (Co), and
c) optionally an external donor (ED).

13. The polymerization process according to claim 12, wherein the internal donor (ID) is selected from malonates, maleates, citraconate, succinates, glutarates, cyclohexene-1,2-dicarboxylates, benzoates, and derivatives and/or mixtures thereof.

14. An article, comprising a polymer composition according to claim 1.
